(19) United States
(12) Patent Application Publication
(10) Pub. No.: US 2006/0285278 A1
(43) Pub. Date: Dec. 21, 2006

(54) DLB electrical box system

(76) Inventor: Jay Coker Tankersley, Georgetown, TX (US)

Correspondence Address: Jay Tankersley, 329 Park Place Drive, Georgetown, TX, 78628, US

(21) Appl. No.: 11/103,811

(22) Filed: Jun. 20, 2005

(51) Int. Cl. H02B 1/00

(52) U.S. Cl. 361/600

(57) ABSTRACT

“The DLB Electrical Box System” is an electrical rough in box for receptacles (wall plugs) and light switches. It houses a module (such as a computer chips value to a computer) inside the box that correctly wires the receptacle or switch once the receptacle and cover are snapped into place. A DLB Wedge quickly connects Romex style wire to the DLB box. All connections on the wedge and box are color coded to ensure proper wiring.

### TECHNICAL FIELD

This invention relates to the electrical component industry. It is an electrical box system for electrical plugs and light switches. It can be used in new construction as well as remodeling. It can easily be adapted for commercial use utilizing conduit and flexible pipe. The DLB box incorporates a module inside of the box that not only eliminates the need for wire nuts, but virtually eliminates the chance of an electrical box being wired incorrectly.

The DLB Electrical box system incorporates a completely new wiring design and allows an electrician to save well over half the time it normally takes to finish wiring a typical plug or light switch. The DLB box will also allow the “do it yourselfers” to wire ‘add on’ electrical features to their own house with almost no chance of incorrectly wiring the plug or switch. It makes wiring almost automatic due to the module (think of it as a large computer chip) that internally makes the connections inside the box. The electrical plug and cover snap securely into place once the box is mounted and assures proper wiring automatically.

Current Method

When an electrician wires a house with the current technology, they must mount the box. Then pull the romex style wire into the box, wait for sheet rockers to finish, then they must strip the wire. After they strip the wire they then bend it around the receptacle screws and force all the wires back in the box while trying to screw in the receptacle, then mount the faceplate. This method is extremely time consuming, has potential for miss-wiring mistakes, and the potential for wires to come off the screws as the receptacle is mounted. That makes the current method, time costly, and potentially dangerous.

The DLB Electrical Box Advantages

With the DLB Electrical Box System, the DLB Box is mounted on the wall stud, and the hot, neutral, and ground wires are connected to the DLB Snap Wedge. The DLB Snap Wedge is then inserted and locked into the DLB Box. The rough in work is now complete. Once the sheet rockers are finished, a DLB faceplate with connectors are snapped securely into the DLB Box. This saves a tremendous amount of time and resources to complete this task. Inside the DLB Box is a “receptacle module” that insures the wiring is always correct. Two internal screws can be removed and the DLB Receptacle Module can be replaced with a DLB Light Switch Module for light switching purposes. The DLB Electrical Box System virtually guarantees wiring is done correctly. It saves a tremendous amount of time and is far safer than any conventional method.

### DRAWINGS

Drawing One (1) depicts the DLB Snap Wedge. It is designed to accepted the three wires that makeup Romex wire. The wire is stripped and inserted into the DLB Snap Wedge, then the three screws are securely tightened. It is now ready to be snapped (locked) into the DLB Box.

Drawing One (1) Figure A (1A) shows the back of the DLB Snap Wedge in order to show the three contacts that will make contact with the DLB module once it is snapped into place in the DLB Box.

Drawing Two (2) depicts the DLB Electrical box (plastic rough in model). This box is designed to be nailed to the wall stud. The DLB Box has four (4) receiving ports that allows the DLB Snap wedge to be locked in. These ports allow power to be brought to the box and for linking one electrical box to the next electrical box. Inside the box is two threaded holes that allow the DLB Module to be secured into place. Once the module is secured into place it makes contact with the inserted Snap wedge. The DLB electrical boxes meet national electrical codes measurements and requirements.

Drawing Three (3) depicts the DLB Module. This module takes the place of wire and screw connections and wire ties (scotch locks). This module internally connects all four receiving ports on the DLB box. This allows an electrician to link boxes together. On the face of the module is a receiving port that will interlock with the faceplate (receptacle) when it is installed. This module can be taken out of the box and a different type of module can be installed in it's place. For example, a receptacle (wall plug) module could be changed with a switch (light) module for that specific need. A person would not be able to insert a receptacle cover into a light switch module because the receiving plates on the modules would be different. This again insures correct wiring or smart wiring every time. There can be 3 way and four way switch module as well. All current electrical box needs can be formatted into a specific module.

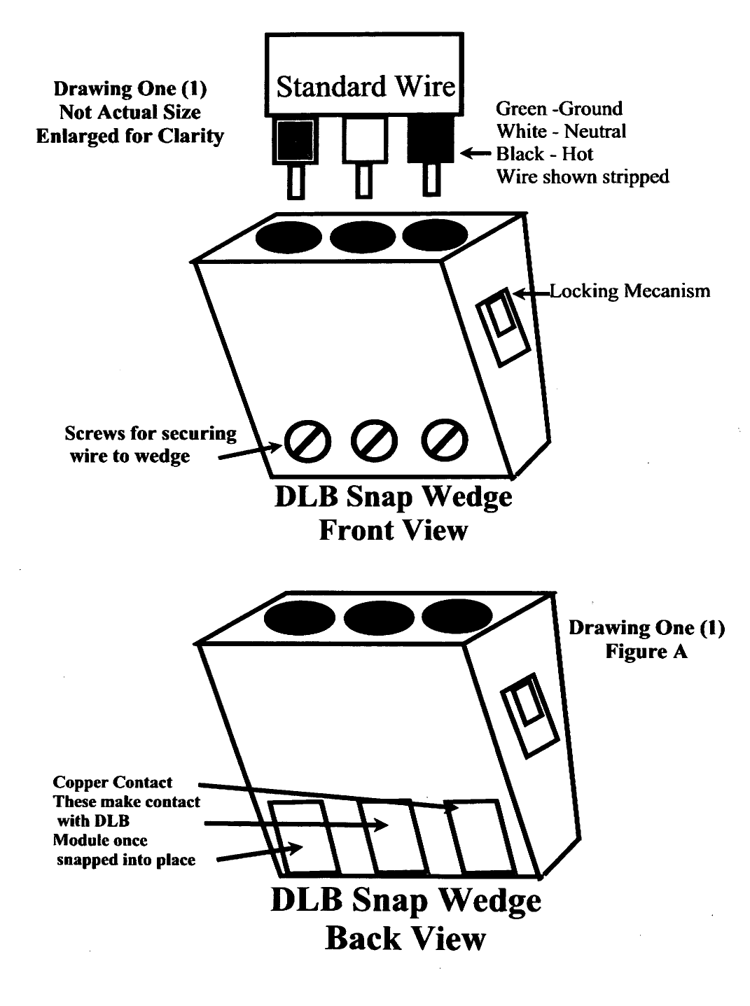

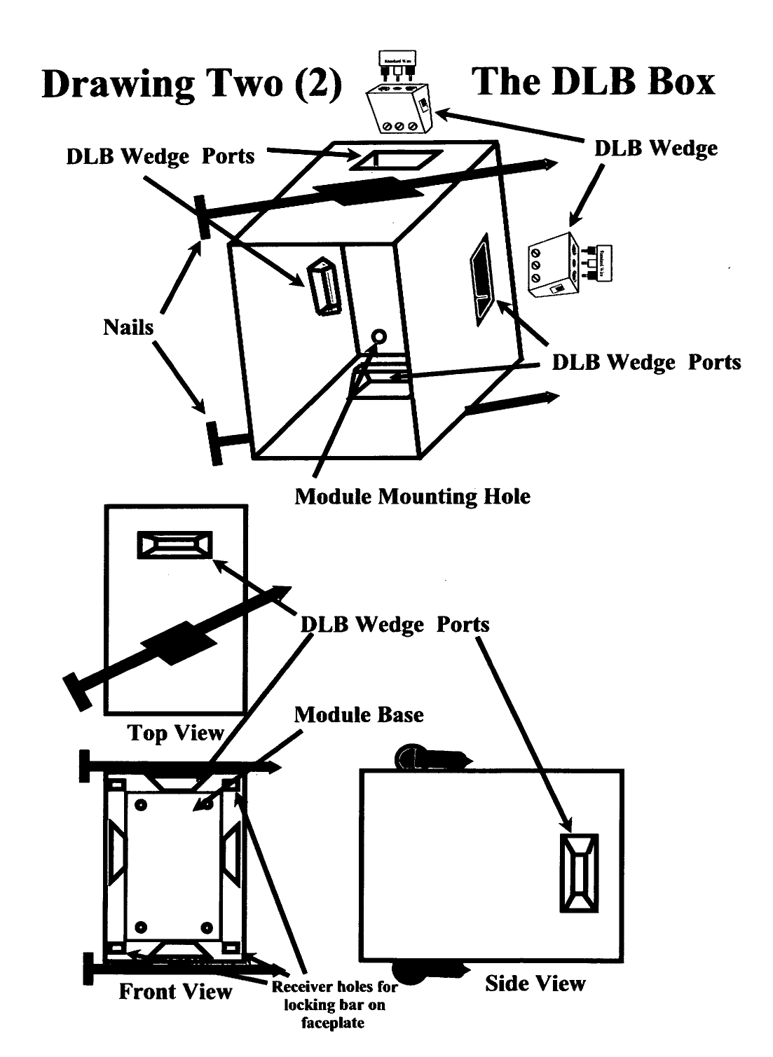

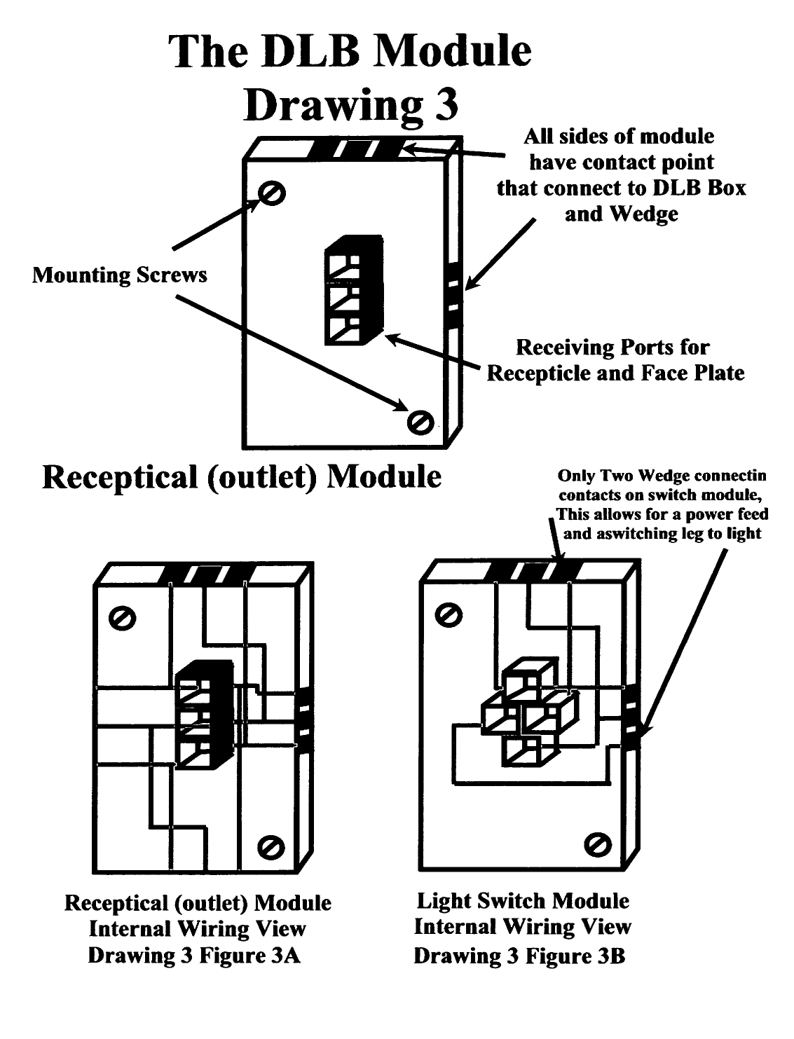

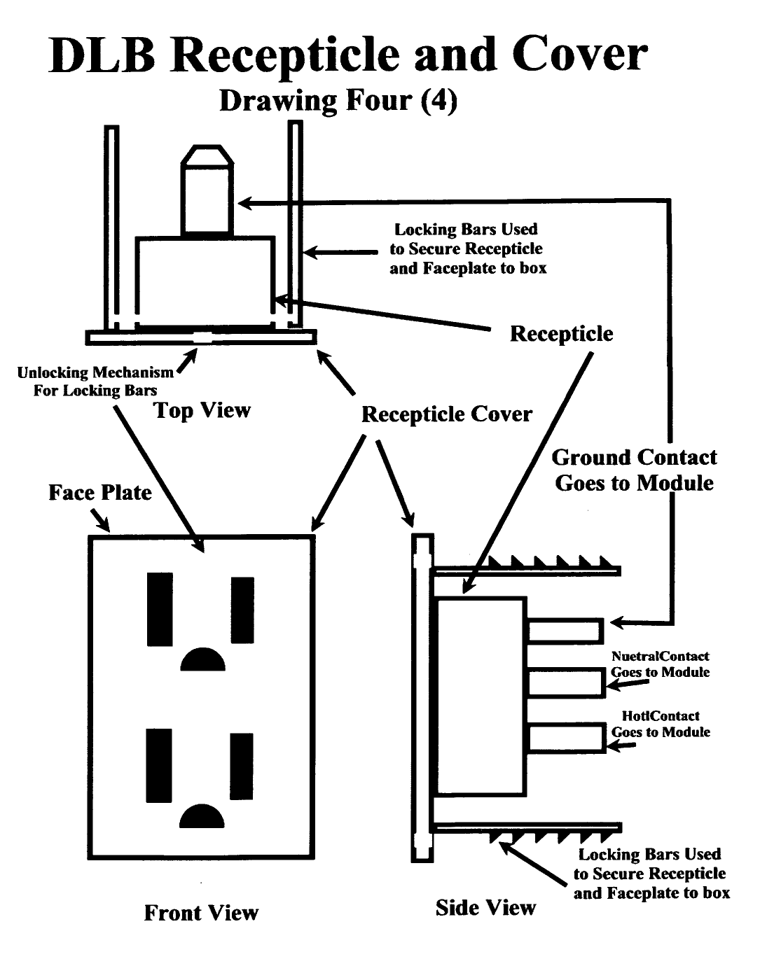

Drawing Three (3) FIG. 3A and FIG. 3B show examples of two internal module configurations. The receptacle configuration 3A. In this example all four sides of the module have contact points that, once mounted in the DLB box make contact with the DLB Wedge. Internally all four grounds are connected together, all for neutrals are connected together and all four hot wires (black wires). The Light Switch 3B, is different, it mounts in the same box but only two sides have contact points. An electrician would bring in the power feed (hot, neutral and ground) to the top of the box and then connect on the other side of the module, a hot feed to the light, the neutral to the light and ground. This ensures simple and perfect wiring every time.

Drawing Four (4) Illustrates the DLB receptacle (outlet) and cover. This unit is am all in one piece. It has a plug on the back that connects directly to the DLB Box and module. It will only go in one way so the connection is always right. It has a one way locking mechanism that will allow the receptacle and cove to push tightly and firmly against the wall but once in place will not pull out during use. A small hole in the cover allows a special tool to be inserted to release the unit for the box and module. This would allow for color changes for the cover or for maintenance purposes. The opening in the cover meet the sized and shape requirements per national electrical code standards.

### RESULTS

The DLB Electrical Box System allows an electrician to wire a house far more quickly than ever before. There are also far less possibilities to make a mistake. This system would also be extremely easy for do it yourselfers to connect wires into the color coded DLB wedge and snap it into place. This product would last for many more years than the typical receptacle because vibration to loosen screws and wires would not come out of wire nuts because there wouldn't be any.

### Alternative Embodiments

The DLB system would be available in any color that could be manufactured according to electrical codes. It could be changed to metal enclosures for industrial and commercial uses. The wedge openings could be designed to accept special conduit and flex connectors while keeping the module concept in place.

The DLB electrical outlet box will revolutionize the electrical industry. It will save billions in labor hours and save thousands of lives with it's superior safety features.

Having described my invention, what I claim, and desire to secure by letters of patent, is as follows:

1. An electrical outlet box that can have wires connected quickly and securely by means of the DLB Wedge. This color coded wedge would eliminate mis-wiring and save time.

2. An electrical outlet box that has a smart module inside that automatically wires the box for the desired application. Example, light switch module or receptacle module depending on the application. This would be accomplished with the DLB Module.

3. A electrical outlet box that can have the light switch or receptacle (outlet) secured and locked to the box when inserted with no tools required. The cover and the switch or receptacle could be one piece. Once these cover/receptacle or switches are locked into the box, all connections would be internally made
